(19) United States
(12) Patent Application Publication
(10) Pub. No.: US 2003/0127573 A1
(43) Pub. Date: Jul. 10, 2003

(54) Playing implement

(76) Inventors: Kenzou Kassai, Osaka-shi (JP); Ichiro Onishi, Osaka-shi (JP)

Correspondence Address: FASSE PATENT ATTORNEYS, P.A., P.O. BOX 726, HAMPDEN, ME, 04444-0726, US

(21) Appl. No.: 10/312,649

(22) PCT Filed: May 17, 2002
(86) PCT No.: PCT/JP02/04825

(30) Foreign Application Priority Data
May 23, 2001 (JP) 2001-154100

(51) Int. Cl. F16M 11/00

(52) U.S. Cl. 248/163.2; 248/440

(57) ABSTRACT

This plaything comprises upwardly convexed arcuate first side support and second side support oppositely arranged on both sides at a prescribed interval for forming side surfaces. A first hanger bar and a second hanger bar coupling the first side support and the second side support with each other for hanging play members thereon are provided on upper portions of the first side support and the second side support. A third hanger bar and a fourth hanger bar for hanging other play members are also provided on lower portions of the first side support and the second side support.

### TECHNICAL FIELD

The present invention relates to a plaything employed indoors for a baby, and more specifically, it relates to a plaything capable of varying the form thereof in response to growth of the baby.

### BACKGROUND ART

For example, Japanese Patent Laying-Open No. 10-192101 discloses a plaything employed indoors for a baby in general. Referring to FIG. 6, this plaything 200 comprises arcuate frame members 210 and 211, employed to cover a baby lying in bed, having upper end portions detachable from each other. Base members 212 and 213 couple the respective lower end portions of the frame members 210 and 211 with each other. Coupling members 214 and 215 are provided between the frame members 210 and 211. It is possible to amuse the baby nestling down in bed by hanging toys, dolls or the like on the frame members 210 and 211 or the coupling members 214 and 215 of the plaything 200 having such a structure.

Such a plaything is preferably employed for hanging toys or the like made of soft materials when the baby is still newborn, and preferably employed for hanging toys having some works, sounding toys or the like when the baby is in its infancy. When the baby is in its toddlerhood, it can practice standing up by holding on to the plaything employed for hanging toys or the like.

When the baby grows up to a certain age, the plaything employed in its infancy is no longer used. Consequently, this plaything is stowed away in a closet, or scrapped. However, this plaything symbolizes the possessor's remembrance of his/her childhood, i.e. the cerebral growth period when he/she enjoyed playing with the parents, and hence he/she can remember the pure love given by the parents and develop a warm heart by occasionally seeing or touching the plaything after growing up and recalling that he/she enjoyed playing with the parents. Further, the plaything can conceivably provide a stimulus effective for the growth of a human, particularly for the growth of the brain.

### DISCLOSURE OF THE INVENTION

The present invention aims at providing a plaything having a structure capable of varying the form thereof to be keepable at hand after the growth of a baby so that the possessor can preserve the plaything employed in his/her infancy all his/her life long.

In order to attain the aforementioned object, the plaything according to the present invention, which is a plaything for hanging play members thereon, comprises first and second side supports oppositely arranged on both sides at a prescribed interval for forming side surfaces and at least two hanger bars provided coupling the aforementioned first side support and the aforementioned second side support with each other for hanging the aforementioned play members thereon.

When this plaything is employed to cover a baby lying in bed, the baby that cannot move around on its own can enjoy playing with the hung play members along with its parents who are affectionate toward it.

In the aforementioned plaything, the aforementioned first and second side supports preferably have upwardly convexed arcuate shapes. In the aforementioned plaything, further, the aforementioned hanger bars are preferably provided to be different in vertical position from each other. According to this structure, the vertical positions of the hanger bars so vary that the same can stimulate the playful mind of the baby and exert good influence on the growth of the brain.

The aforementioned plaything preferably includes first and second hanger bars coupling regions of the aforementioned first side support and the aforementioned second side support close to upper portions with each other and third and fourth hanger bars coupling the aforementioned first side support and the aforementioned second side support with each other on positions downward and outward beyond positions mounted with the aforementioned first and second hanger bars. According to this structure, positions of hung play members differ from each other while the play members are hung on four portions in plane, to be capable of further prompting the curiosity of the baby.

In the aforementioned plaything, the aforementioned hanger bars are preferably detachably provided with respect to the aforementioned first and second side supports. Further, the aforementioned plaything preferably further comprises a strip member to be hung on at least two hanger bars selected from the aforementioned hanger bars for supplying this plaything with the form of a magazine rack or a chair.

According to this structure, the possessor can use the plaything symbolizing the remembrance of his/her childhood, i.e. the cerebral growth period when he/she enjoyed playing with the parents, in the form of a magazine rack or a chair also after growing up, whereby he/she can keep this plaything at hand for occasionally seeing or touching this plaything. Consequently, the possessor can remember the pure love given by the parents and develop a warm heart by occasionally recalling that he/she enjoyed playing with the parents. Further, the plaything can provide an effective stimulus to the possessor in the process of growing up to an adult, particularly in the process of the cerebral growth. In addition, the possessor can preserve the plaything employed in his/her infancy all his/her life long.

### BRIEF DESCRIPTION OF THE DRAWINGS

FIG. 1 is a perspective view showing the whole of a plaything 100 forming a play gym.

FIG. 2 is a perspective view showing the whole of the plaything 100 forming a magazine rack.

FIG. 3 is a sectional view taken along the line III-III in FIG. 2.

FIG. 4 is a perspective view showing the whole of the plaything 100 forming a chair.

FIG. 5 is a sectional view taken along the line V-V in FIG. 4.

FIG. 6 is a perspective view showing the whole of a conventional plaything 200.

### BEST MODES FOR CARRYING OUT THE INVENTION

The structure of a plaything according to an embodiment of the present invention is now described with reference to the drawings. The plaything 100 according to this embodiment has a structure capable of changing the form thereof to the so-called play gym, a magazine rack and a chair. The structure of the plaything 100 is now described with reference to the respective forms.

(Play Gym)

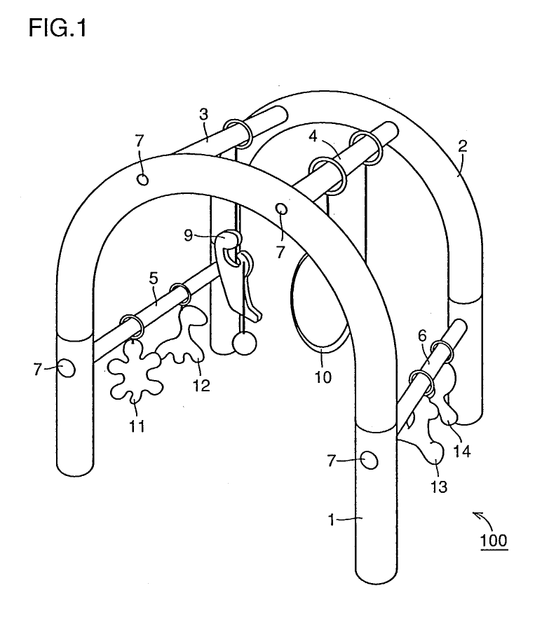

The structure of the plaything 100 forming a play gym is described with reference to FIG. 1. FIG. 1 is a perspective view showing the whole of the plaything 100 forming a play gym. This plaything 100 comprises a first side support 1 and a second side support 2 oppositely arranged on both sides at a prescribed interval for forming side surfaces. According to this embodiment, the first side support 1 and the second side support 2 have upwardly convexed arcuate frame structures.

A first hanger bar 3 and a second hanger bar 4 coupling the first side support 1 and the second side support 2 with each other for hanging play members thereon are provided on upper portions of the first side support 1 and the second side support 2. The first hanger bar 3 and the second hanger bar 4 are detachably provided with respect to the first side support 1 and the second side support 2 with screws 7 or the like. The first hanger bar 3 and the second hanger bar 4, provided to be parallel to each other on the same vertical positions with respect to the first side support 1 and the second side support 2 in this embodiment, can be rendered different in vertical position from each other, or can be obliquely mounted.

A third hanger bar 5 and a fourth hanger bar 6 for hanging play members thereon are also provided on lower portions of the first side support 1 and the second side support 2. The third hanger bar 5 and the fourth hanger bar 6 are mounted on positions downward beyond the first side support 1 and the second side support 2 respectively, while the third hanger bar 5 is mounted on a position outward beyond the first hanger bar 3 and the fourth hanger bar 6 is mounted on a position outward beyond the second hanger bar 4. The third hanger bar 5 and the fourth hanger bar 6 are also detachably mounted with respect to the first side support 1 and the second side support 2 with screws 7 or the like.

In this embodiment, an object 9 of wood modeled on a mother is hung on the first hanger bar 3, a disk 10 forming a mirror is hung on the second hanger bar 4, and characters 11, 12, 13 and 14 consisting of soft materials modeled on imaginary animals are hung on the third hanger bar 5 and the fourth hanger bar 6 as the hung play members. The third hanger bar 5 and the fourth hanger bar 6, provided to be parallel to each other on the same vertical positions with respect to the first side support 1 and the second side support 2, can be rendered different in vertical position from each other, or can be obliquely mounted.

When the aforementioned plaything 100 forming a play gym is employed to cover a baby lying in bed, the baby that cannot move around on its own can enjoy playing with the hung play members along with its parents who are affectionate toward it. Further, the positions of the hanger bars so vary that the positions of the hung play members differ from each other while the play members are hung on four portions in plane, so that the plaything can further prompt the curiosity of the baby.

While the plaything employs four hanger bars in the above description, the number of the hanger bars is not restricted to four but can be arbitrarily selected so far as the plaything employs at least two hanger bars for rendering the first side support 1 and the second side support 2 self-supporting.

(Magazine Rack)

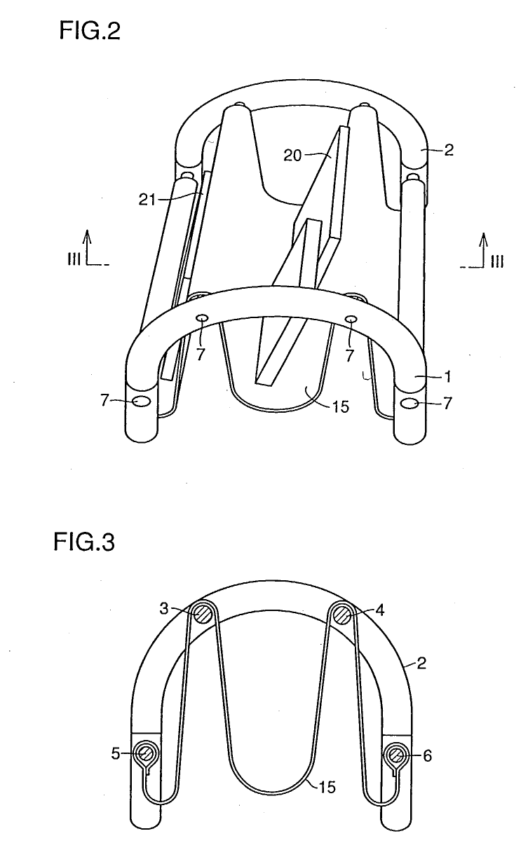

The structure of the plaything 100 forming a magazine rack is now described with reference to FIGS. 2 and 3. FIG. 2 is a perspective view showing the whole of the plaything 100 forming a magazine rack, and FIG. 3 is a sectional view taken along the line III-III in FIG. 2.

In the plaything 100 forming a magazine rack, the hung play members are removed, and both end portions of a strip member 15 consisting of cloth, vinyl or the like are fixed to the third hanger bar 5 and the fourth hanger bar 6 as shown in the sectional view of FIG. 3 so that the central region of the strip member 15 droops from the first hanger bar 3 and the second hanger bar 4. When the strip member 15 is employed in this manner for forming a storage space for supporting picture books 20 and a magazine 21, the plaything 100 can be employed as a magazine rack. While all hanger bars are employed in the state shown in FIGS. 2 and 3, the hanger bars can be selectively removed for forming a magazine rack in an arbitrary shape.

(Chair)

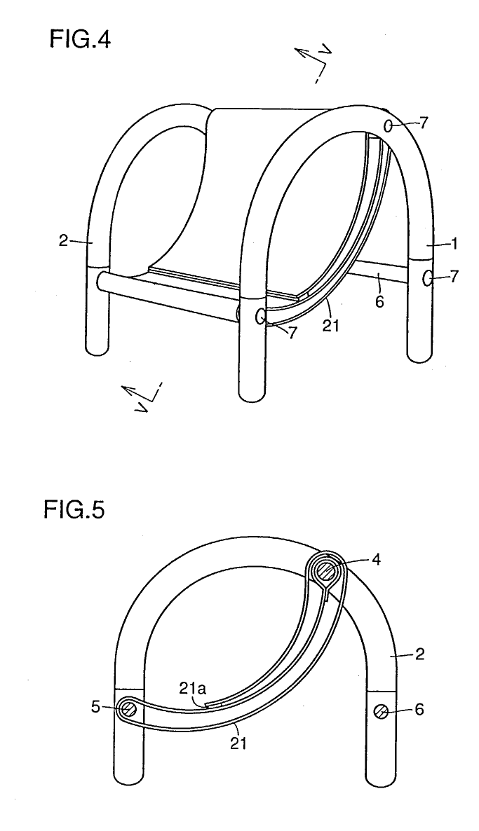

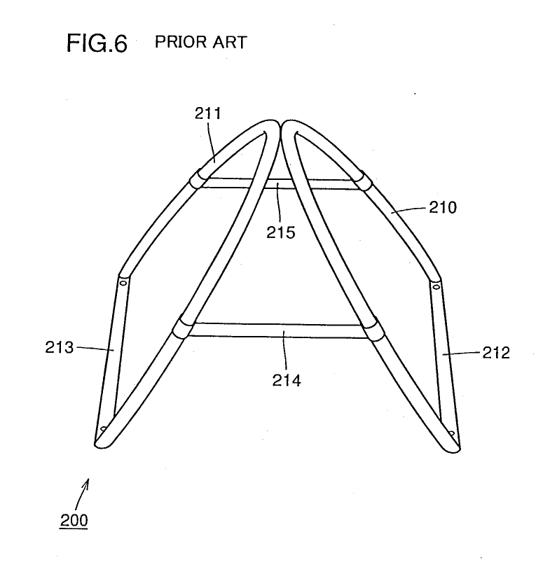

The structure of the plaything 100 forming a chair is now described with reference to FIGS. 4 and 5. FIG. 4 is a perspective view showing the whole of the plaything 100 forming a chair, and FIG. 5 is a sectional view taken along the line V-V in FIG. 4.

In the plaything 100 forming a chair, the play members to be hung and the first hanger bar 3 are removed, an end of a strip member 21 consisting cloth, vinyl or the like is fixed to the second hanger bar 4 as shown in the sectional view of FIG. 5, the strip member 21 is wound on the third hanger bar 5, the strip member 21 is further wound on the second hanger bar 4 and the other end of the strip member 21 is thereafter fixed to the strip member 21 with fixing members 2 la such as hooks.

When the strip member 21 is employed in this manner for forming a seat portion and a backrest, the first side support 1 and the second side support 2 serve as armrests so that the plaything 100 can be employed as a chair.

(Function/Effect)

As hereinabove described, the form of the plaything 100 according to this embodiment can be changed into that of a play gym, that of a magazine rack and that of a chair. Thus, the possessor can use this plaything 100 symbolizing the remembrance of his/her childhood, i.e. the cerebral growth period when he/she enjoyed playing with the parents while changing the form also after growing up, whereby he/she can occasionally see or touch this plaything 100 by keeping this plaything 100 at hand. Consequently, the possessor can remember the pure love given by the parents and develop a warm heart by occasionally recalling that he/she enjoyed playing with the parents. Further, the plaything can provide an effective stimulus to the possessor in the process of growing up to an adult, particularly in the process of the cerebral growth. In addition, the possessor can preserve the plaything employed in his/her infancy all his/her life long.

The embodiment disclosed this time is illustrative in all points and not restrictive. The scope of the present invention is shown not by the above description but by the scope of claim for patent, and it is intended that all modifications within the meaning and the scope equivalent to the scope of claim for patent are included.

Industrial Applicability

The possessor of the plaything according to the present invention can use this plaything symbolizing the remembrance of his/her childhood, i.e. the cerebral growth period when he/she enjoyed playing with the parents, in the form of a magazine rack or a chair also after growing up, whereby he/she can keep this plaything at hand for occasionally seeing or touching this plaything. Consequently, the possessor can remember the pure love given by the parents and develop a warm heart by occasionally recalling that he/she enjoyed playing with the parents. Further, the plaything can provide an effective stimulus to the possessor in the process of growing up to an adult, particularly in the process of the cerebral growth. In addition, the possessor can preserve the plaything employed in his/her infancy all his/her life long.

1. A plaything for hanging play members thereon, comprising:
first and second side supports oppositely arranged on both sides at a prescribed interval for forming side surfaces; and
at least two hanger bars provided for coupling said first side support and said second side support with each other for hanging said play members thereon.

2. The plaything according to claim 1, wherein said first and second side supports have upwardly convexed arcuate shapes.

3. The plaything according to claim 1, wherein said hanger bars are provided to be different in vertical position from each other.

4. The plaything according to claim 1, including:
first and second hanger bars coupling regions of said first side support and said second side support close to upper portions with each other, and
third and fourth hanger bars coupling said first side support and said second side support with each other on positions downward and outward beyond positions mounted with said first and second hanger bars.

5. The plaything according to claim 1, wherein said hanger bars are detachably provided with respect to said first and second side supports.

6. The plaything according to claim 1, further comprising a strip member to be hung on at least two hanger bars selected from said hanger bars for supplying said plaything with the form of a magazine rack or a chair.
